(19) United States
(12) Patent Application Publication
(10) Pub. No.: US 2012/0034047 A1
(43) Pub. Date: Feb. 9, 2012

(54) FASTENER

(75) Inventors: ZHENG-HENG SUN, Tu-Cheng (TW); JUN HE, Shenzhen City (CN); AN-GANG LIANG, Shenzhen City (CN)

(73) Assignees: HON HAI PRECISION INDUSTRY CO, LTD., Tu-Cheng (TW); HONG FU JIN PRECISION INDUSTRY (ShenZhen) CO,LTD., Shenzhen City (CN)

(21) Appl. No.: 12/857,505

(22) Filed: Aug. 16, 2010

(30) Foreign Application Priority Data
Aug. 4, 2010 (CN) 201010245100.2

(51) Int. Cl. F16B 33/00; F16B 43/00

(52) U.S. Cl. 411/371.2; 411/337

(57) ABSTRACT

A fastener includes a head, a threaded shaft, a latching member, and a flexible washer. The threaded shaft extends from the head. The latching member extends from peripheral of the threaded shaft and adjacent to the head. The washer latches onto the latching member.

### BACKGROUND

1. Technical Field

The present disclosure relates to fasteners, and particularly to a screw-type fastener.

2. Description of Related Art

On circuit boards, some elements need to be fixed to the circuit boards with screws. However, during installation of the screws, an operator may accidentally scratch the surface of the circuit boards, thus damaging traces on the circuit boards.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a screw.

FIG. 2 is an assembled view of the screw of FIG. 1.

FIG. 3 is a cross-sectional view of the screw of FIG. 2.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

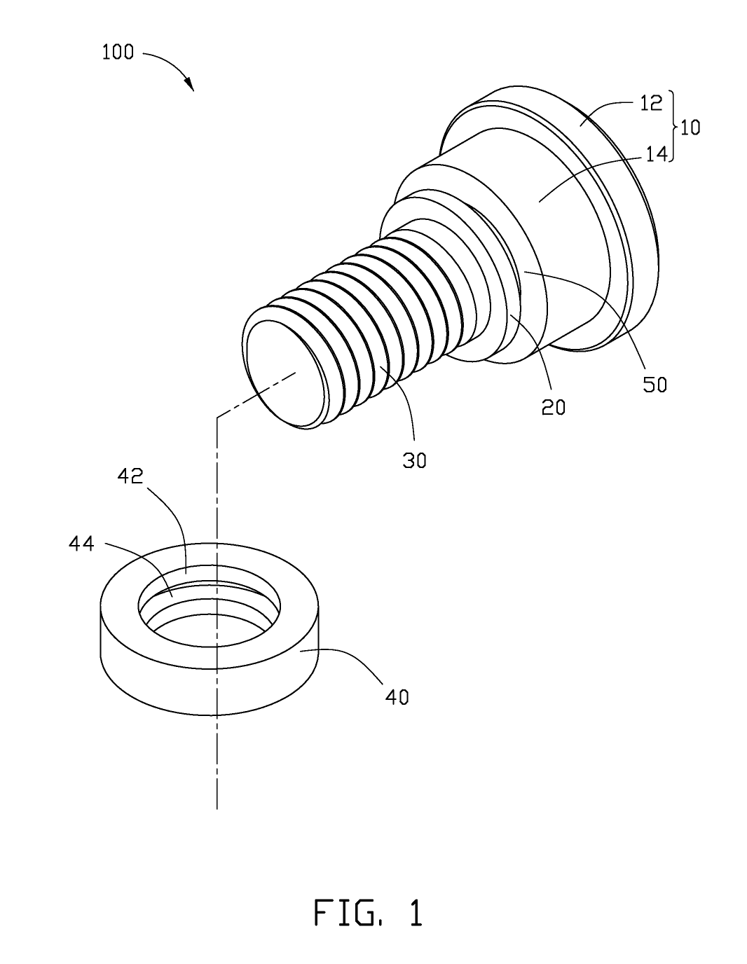

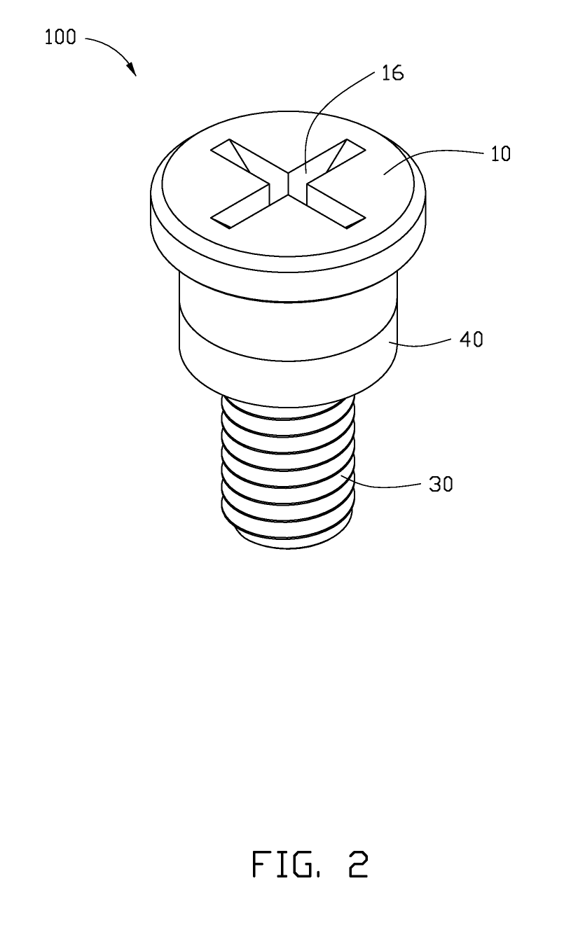

Referring to FIGS. 1 to 3, an embodiment of a screw 100 includes a head 10, a threaded shaft 30 extending from the head 10, a latching member 20, and a washer 40. The washer 40 is made of flexible material, such as polycarbonate or nylon. The head 10, the latching member 20, and the threaded shaft 30 are made of metal material, such as steel or iron.

The head 10 is stepped and includes a first column 12 and a second column 14. The top surface of the first column 12 defines a drive 16, such as slotted, Phillips, etc. The second column 14 extends from a bottom of the first column 12. The diameter of the second column 14 is less than the diameter of the first column 12. The threaded shaft 30 extends from the center of the bottom of the second column 14. In other embodiments, the head 10 may comprise just one column.

The latching member 20 extends from a periphery of the threaded shaft 30 adjacent to the second column 14. The latching member 20 is also a column, the diameter of the latching member 20 is less than the diameter of the second column 14. A groove 50 is defined between the latching member 20 and the second column 14.

The washer 40 is ring-shaped. An inner sidewall 42 of the washer 40 defines a circular groove 44. The outer diameter of the washer 40 is substantially equal to the diameter of the second column 14. The inner diameter of the washer 40 is substantially equal to the diameter of the groove 50. The diameter of the groove 44 is substantially equal to the diameter of the latching member 20. Distance between the groove 44 and the top of the washer 40 and a distance between the groove 44 and the bottom of the washer 40 are both substantially equal to the width of the groove 50.

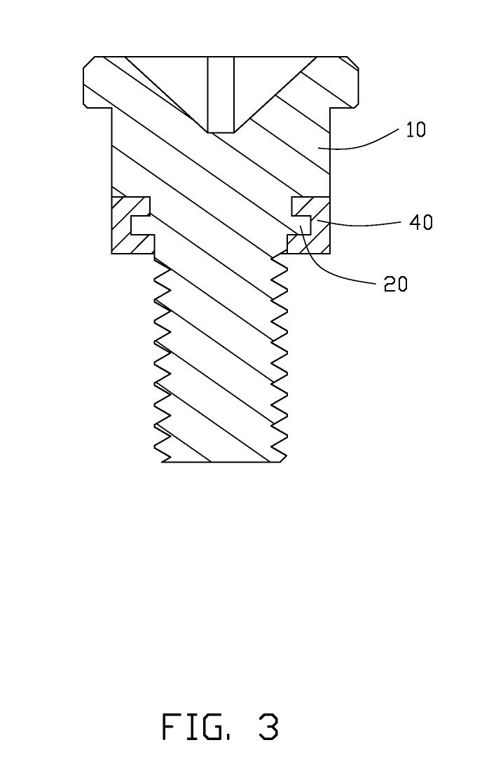

Referring to FIG. 3, in assembly, the flexible washer 40 is deformed and the latching member 20 is engaged in the groove 44. When fixing an element on a circuit board using the screw 100, the flexible washer 40 is sandwiched between the circuit board and the screw head 10, thereby protecting traces on the circuit board from being scratched during installation of the screw 100.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A fastener comprising:
a head;
a threaded shaft extending from the head;
a latching member extending from a periphery of the threaded shaft and adjacent to the head; and
a washer latched onto the latching member;
wherein the washer is made of flexible material.

2. The fastener of claim 1, wherein the head is stepped and comprises a first column and a second column, the second column extends from a bottom of the first column, the diameter of the second column is less than the diameter of the first column.

3. The fastener of claim 2, wherein the latching member is a column, the diameter of the latching member is less than the diameter of the second column, a groove is defined between the latching member and the second column, the washer is ring-shaped, an inner sidewall of the washer defines a circular groove, the outer diameter of the washer is substantially equal to the diameter of the second column, the inner diameter of the washer is substantially equal to the diameter of the groove between the latching member and the second column, the diameter of the circular groove of the washer is substantially equal to the diameter of the latching member, a distance between the groove and the top of the washer is substantially equal to the width of the slot.

4. The fastener of claim 1, wherein the flexible material is polycarbonate or nylon.
